(19) United States
(12) Patent Application Publication
(10) Pub. No.: US 2014/0229966 A1
(43) Pub. Date: Aug. 14, 2014

(54) REAL-TIME VIEWING AND OPINION ANALYTICS FOR CONNECTED DEVICES

(71) Applicants: Kadari Subba Rao Sudeendra Thirtha Koushik, Bangalore (IN); Shashidhar Krishnamurthy, Noida (IN)

(72) Inventors: Kadari Subba Rao Sudeendra Thirtha Koushik, Bangalore (IN); Shashidhar Krishnamurthy, Noida (IN)

(21) Appl. No.: 13/766,769

(22) Filed: Feb. 13, 2013

(51) Int. Cl. H04N 21/442

(52) U.S. Cl. CPC H04N 21/44222
USPC 725/14

(57) ABSTRACT

The embodiments disclosed herein relate to a method and system for viewership analysis of a program with or without user intervention as disclosed in the embodiments herein. The system uses either a comment analysis method which requires user inputs or a time measurement method which does not require user inputs, based on user preference. In the comment analysis method, the user is provided with certain pre-stored questions. For these questions, the system fetches user feedbacks and calculates an average rating corresponding to the fetched user feedbacks. In the time measurement method, each program is assigned with a unique Id. Further, the system measures and records certain parameters related to the program for which the rating is to be calculated. Further, using the recorded parameters, the system calculates an average rating for that particular program. The system may use a dedicated channel for the viewership analysis purpose.

The present application is based on, and claims priority from, IN Application Number 540/CHE/2012, filed on 14 Feb. 2012, the disclosure of which is hereby incorporated by reference herein.

### TECHNICAL FIELD

The embodiments herein relate to television networks and, more particularly, to a method and system for collecting viewing statistics of programs with or without user intervention in television networks.

### BACKGROUND

For television (TV) service providers, it is important to obtain rating of programs being telecasted in the TV. The program ratings may help the service providers to check which program has more viewers and which program(s) has less viewership count. Based upon the rating of each programs, the service providers can decide if a particular program is to be terminated or telecasted further. The program ratings can be further used to decide advertisement slots that can be reserved in between each program. Further, the rate at which the advertisement clients may be charged depends on the rating of the program during which the advertisement is telecasted.

One of the existing systems for collecting viewership statistics requires special boxes to be implemented in a selected sample of homes across the region of coverage. The viewers in the sample of homes are given special instructions to follow based upon watching preferences. The boxes installed at the viewer records special information to enhance the understanding of viewer preference. The information so collected is processed separately by an independent party which is further analyzed and marked for Television Rating Points (TRP). These processes may be carried out by a private organization who then sells the identified ratings to various TV or by media companies. The TV and media companies can further analyze this data and identify which programs are more popular, which advertisement slots are more chargeable and any such related information. The disadvantage of this method is that the private organizations which perform the analysis may charge high rates to provide the information to the TV companies. Further, the logistics required for this process may be costly. Further, the low sample size may even have an adverse impact on the accuracy of measurement. Further, this measurement method is prone to human errors.

### SUMMARY

In view of the foregoing, an embodiment herein provides a method for collecting parameters related to viewership of television programs, the method comprising of recording statistics related to at least one television program by a user device; and transmitting the statistics to a remote location using internet.

Embodiments herein disclose a device for collecting parameters related to viewership of television programs, the device comprising at least one means configured for recording statistics related to at least one television program; and transmitting the statistics to a remote location using internet.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a general block diagram which shows internet connected TV system as disclosed in the embodiments herein;

FIG. 2 illustrates a general block diagram which shows components of a back end analysis engine as disclosed in the embodiments herein;

FIG. 3 illustrates a flow diagram which shows various steps involved in the process of comment analysis method for viewership analysis as disclosed in the embodiments herein; and

FIG. 4 illustrates a flow diagram which shows various steps involved in the process of time measurement method for viewership analysis as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

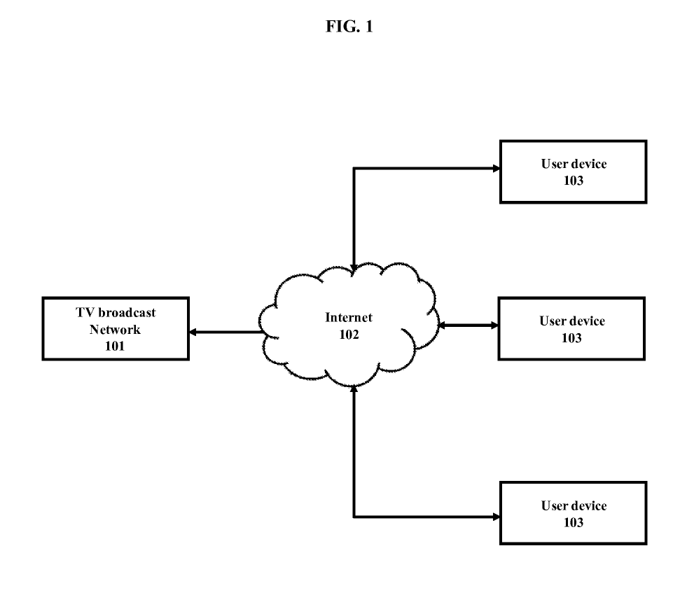

The embodiments herein disclose a method and system for collecting and analyzing viewing statistics as to which program is being watched and how long and related information, online with or without user intervention in a television network. Referring now to the drawings, and more particularly to FIGS. 1 through 4, where similar reference characters denote corresponding features consistently throughout the figures, there are shown embodiments.

FIG. 1 illustrates a general block diagram which shows internet connected TV system as disclosed in the embodiments herein. The system comprises a TV broadcasting network 101, internet 102 and plurality of user devices 103. The user devices 103 are connected to the TV broadcasting network 101 through a suitable means such as internet 102. The user device 103 may be a Television (TV), a TV with a Set Top Box connected to it, a Personal computer with a TV tuner card, online TV facility or any such device capable of accessing and displaying a television channel and has access to the internet. In one embodiment, there may be a camera connected to the user device and adapted to take pictures and/or videos of the scene in front of the camera. In one embodiment, the user may be provided with a login Id and password in order to login to the internet 102 from the user device 103. Further, the internet 102 may comprise a dedicated module for obtaining user comments or opinions. In one embodiment, the dedicated module for obtaining user comments and/or opinions may be a back end analysis engine. In one embodiment, the opinions and comments from the users may be used to perform viewership analysis, which in turn may help the TV companies to identify ratings of each programs being telecasted. Further, the program ratings may be used to identify which program slots are more popular, which inturn may help the TV companies to decide the rate at which advertisement companies are to be charged for the advertisement slots. The proposed embodiment may also be used for applications such as voting for reality shows, opinion polls, sharing and for any such application. In one embodiment, the proposed embodiment may implement a dedicated channel for data transmission required for viewership analysis.

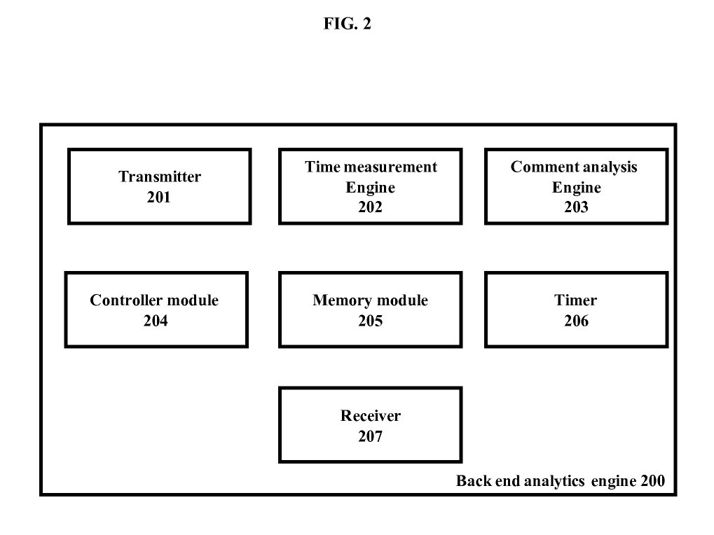

FIG. 2 illustrates a general block diagram which shows components of a back end analysis engine as disclosed in the embodiments herein. The system comprises a transmitter 201, a time measurement engine 202, a comment analysis engine 203, a controller 204, a memory module 205, a timer 205 and a receiver 206. The back end analysis engine 200 may be present as a part of the internet 102 or the TV broadcasting network 101 in the internet TV system. The back end analysis engine 200 may use different methods to perform viewership analysis of programs. In one embodiment, the different methods for performing viewership analysis may comprise time measurement analysis method and comment analysis method. In another embodiment, the back end analysis engine 200 may use any of time measurement analysis method, comment analysis method or both for obtaining viewer opinions or comments. In one embodiment, the viewer opinions or comments obtained by the back end analysis engine 200 may be related to program viewership statistics or polls or voting for reality shows and so on. In the time measurement analysis method, the time measurement engine 202 performs viewership analysis using a program Id assigned to each program and associated parameters. The associated parameters may comprise system time, login Id, user profile and so on. In the comment analysis method, the comment analysis engine 203 performs the viewership analysis based on the comments/feedback received from the user 103. Further, the comment analysis engine 203 may use the transmitter 201 and the receiver 207 for exchanging information between the back end analysis engine 200 and the user devices 103. The controller module 204 controls and coordinates various processes performed by the back end analysis engine 200. The memory module 205 may be used to store informations such as user profiles, program Ids, various data collected by the time measurement engine 202 comprising program running information, login Id of user and/or any such data. This storage can be in the device or on the cloud (internet) or as a part of the back end engine. Further, the timer 206 may be used by the time measurement engine 202 to measure program information and associated data in a set time interval. In one embodiment, a network administrator or any such authorized person may set the time period for measurement using the timer 206. The controller module 204 may also receive inputs from the camera, which may be in the form of images and/or video. The controller module 204 processes the inputs using suitable means to identify number of viewers watching the TV at the instant the image/video was taken. The controller module 204 may also identify various characteristics of the viewers such as approximate ages and so on from the image/video.

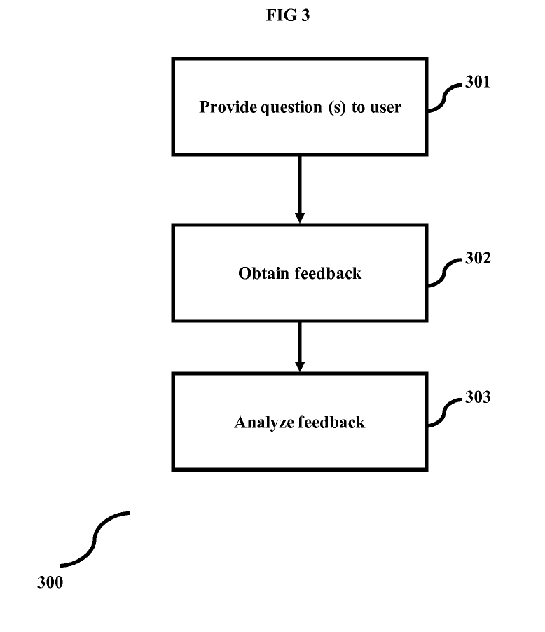

FIG. 3 illustrates a flow diagram which shows various steps involved in the process of comment analysis method for viewership analysis, as disclosed in the embodiments herein. The comment analysis method based viewership analysis is performed by the comment analysis engine 203 present in the back end analysis engine. In this method, the comment analysis engine 203 provides (301) certain questions to the user. The questions may be sent to the user using the transmitter 201 present in the back end analysis engine 200. In one embodiment, the questions may be predefined questions related to viewer satisfaction and may be stored in the memory module 205. In another embodiment, the questions may appear as a pop-up message or else may be opened by accessing a mail box. Further, the comment analysis engine 203 obtains (302) feedback from the user. In one embodiment, the user may be provided with certain options with each question and the user may be asked to choose at least one option which may be considered as the feedback from user for that particular question. For example, the questions may be related to the number of people viewing the television, their range of ages, their personal profiles and so on. The user may provide feedback to the questions using a suitable user interface. In one embodiment, the user interface may be a remote, touch screen, switches in the user device 103 and/or any such suitable interface. Further, the user feedbacks are sent to the comment analysis engine 203. Further, the comment analysis engine 203 analyzes (303) the feedbacks received from the user. The user feedback obtained using this method can be used for various processes such as measuring viewership ratings of programs, obtaining viewer opinion in polls, voting for reality shows and so on. In one embodiment, the comment analysis engine 203 may have a look up table (LUT) which comprises ratings corresponding to each feedback. Further, the comment analysis engine 203, from the LUT, obtains ratings corresponding to the received user comments and calculates an average rating for that particular program. The various actions in method 300 may be performed in the order presented, in a different order or simultaneously. Further, in some embodiments, some actions listed in FIG. 3 may be omitted.

In an embodiment herein, the user may not be asked questions related to the number of viewers watching the program, ages of the viewers and so on. The camera may take images and/or video of the scene in from of the device at periodic intervals or on receiving pre-defined triggers (such as a channel being changed, a channel being constantly viewed for a specified time and so on). The images/video are then processed by the backend analytics engine 200 to extract information such as but not limited to number of viewers watching the program, approximate age of the viewers and so on.

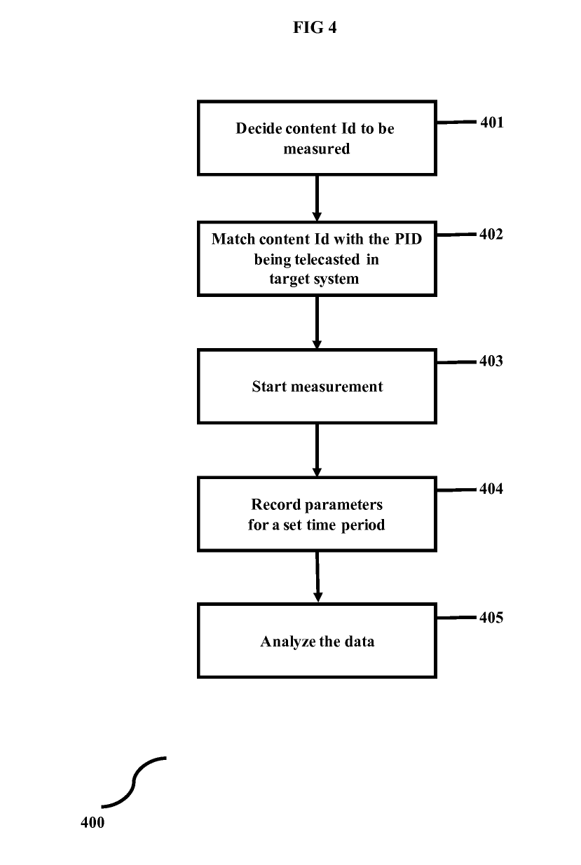

FIG. 4 illustrates a flow diagram which shows various steps involved in the process of time measurement method for viewership analysis as disclosed in the embodiments herein. The time measurement method for viewership analysis is performed by the time measurement engine 202 in the back end analysis engine 200. In order to perform the time measurement based analysis, each program for which the ratings are to be calculated is assigned with an Id. The Id may be unique to each program. Initially the time measurement engine 202 decides (401) the content/program for which the rating is to be measured and fetches Id corresponding to the selected program. Further, the time measurement engine 202 tries to match (402) the fetched content Id with the Id of the program (PID) being telecasted and being selected for display (viewing) through the target system until the fetched content Id matches with the PID of the program being telecasted at that instant on the target system. Once the fetched content Id matches with the PID of a program, the time measurement engine 202 starts (403) measurement of the program parameters. Further, the time measurement engine 202 records (404) the parameters related to that particular program. The time measurement engine 202 may record the parameters related to intended program for a set time period. Further, the time period for which the program parameters are fetched and recorded may be set using a timer 206 associated with the back end analysis engine 200. The recorded parameters may comprise system time, login Id, user profile and so on. Once the set time period is over, the time measurement engine 202 stops measurement and analyzes (405) the recorded data. In one embodiment, the information collected by analyzing the recorded data may be used to build user profiles. The user profiles may be in the form of graphs or tables or any such format. Further, the user profiles may be analyzed to identify user preference of each program. In another embodiment, the recorded data may be analyzed to build program profiles specific to each program. Further, the program profiles may be analyzed to check popularity of each program. The various actions in method 400 may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the network elements. The network elements shown in FIG. 2 include blocks which can be at least one of a hardware device, or a combination of hardware device and software module.

The embodiment disclosed herein specifies a system for database management in a communication network. The mechanism allows uploading and retrieval of contents from a system recycle bin from and to a cloud bank, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A method of computing data by at least a processor, by at least collecting parameters related to viewership of at least a television program, said method comprising:
recording at least statistics related to said television program by a user device;
capturing at least one of an image and a video of a scene in front of said user device while said television program is being viewed by a capturing device;
transmitting at least data containing at least one of said statistics and said image and said video to at least a remote location using a data communication network; and
analyzing said transmitted data at least at said remote location by said processor, wherein said processor is configured to generate at least viewership data for at least one of a television channel or said television program.

2. The method as claimed in claim 1, wherein said statistics comprises at least one of an ID of said television program and a time for which said television program was accessed.

3. The method as claimed in claim 2, wherein said television program is identified using a content ID, wherein said content ID is derived from a program guide, wherein said program guide is obtained from said user device.

4. The method as claimed in claim 1, wherein said method further comprises:
asking at least a question, wherein said question is configured to be answered by a user on at least a television set, wherein said question is configured to be asked at least at one of during, before and after said television program; and
transmitting an answer to said question using a data communication network.

5. The method as claimed in claim 4, wherein said question is related to said television program.

6. (canceled)

7. (canceled)

8. The method as claimed in claim 4, wherein said question appears as a pop up on said television set.

9. (canceled)

10. A device for computing data by at least collecting parameters related to viewership of at least a television program, said device comprising:
at least a user device configured for recording at least statistics related to said television program;
at least a scene capturing device configured for capturing at least one of an image and a video of a scene in front of said user device while said television program is being viewed;
at least a transmitting device configured for transmitting data containing at least one of said statistics and said image and said video to at least a remote location using a data communication network; and
at least a processor configured for analyzing said transmitted data at least at said remote location, wherein said processor is configured to generate at least viewership data for at least one of a television channel or said television program.

11. The device as claimed in claim 10, wherein said device is configured for recording statistics comprising of at least one of ID of said television program; and time for which said television program was accessed.

12. The device as claimed in claim 11, wherein said television program is identified using a content ID, wherein said content ID is derived from a program guide, wherein said program guide is obtained from at least one of said Television; or said Set Top Box.

13. The device as claimed in claim 10, wherein said device is configured for:
asking at least a question, wherein said question is configured to be answered by a user on at least a television set, wherein said question is configured to be asked at least at one of during, before and after said television program; and
transmitting an answer to said question using a data communication network.

14. (canceled)

15. (canceled)

16. The device as claimed in claim 13, wherein said device is configured for making said question appear as a pop up on said television set.

17. (canceled)
